(19) United States
(12) Patent Application Publication
(10) Pub. No.: US 2026/0349791 A1
(43) Pub. Date: Nov. 5, 2026

(54) AGENT TASK EXECUTION METHOD, SYSTEM AND MEDIUM

(71) Applicant: XG TECH PTE. LTD., Singapore (SG)

(72) Inventors: Wei LIN, Singapore (SG); Zizhen XUE, Singapore (SG); Yichen GONG, Singapore (SG)

(73) Assignee: XG TECH PTE. LTD., Singapore (SG)

(21) Appl. No.: 19/725,805

(22) Filed: Jun. 30, 2026

(30) Foreign Application Priority Data
Jan. 27, 2026 (CN) 202610113644.4

(51) Int. Cl. G06F 9/48

(52) U.S. Cl. CPC G06F 9/4881

(57) ABSTRACT

Embodiments of the present disclosure relate to the technical field of intelligent assistants, and provide an agent task execution method, system and medium. The method comprises: sending, by a first end, a target task to a second end; starting from a unified starting-point state of the target task, performing parallel exploration by using a plurality of branch agents, to obtain a target path corresponding to the target task; sending, by the second end, the target path to the first end; and executing, by the first end, the target task based on the target path by using a primary agent.

### CROSS-REFERENCE TO RELATED APPLICATION

This application claims priority to and the benefit of Chinese Patent Application No. 202610113644.4 filed on Jan. 27, 2026, incorporated herein by reference.

### TECHNICAL FIELD

The present disclosure relates to the technical field of artificial intelligence, and in particular, to an agent task execution method, system, medium, and electronic device.

### BACKGROUND

A graphical user interface (GUI) agent (hereinafter referred to as an agent) is an artificial intelligence program capable of simulating human interaction with software interfaces, and is capable of completing specific tasks by performing operations (such as clicking, swiping, and inputting text) on various software interfaces, thereby improving operational efficiency and the level of automation. Currently, agents can be applied in scenarios requiring automated operation of graphical user interfaces, such as robotic process automation (RPA), automated software testing, and intelligent personal assistant scenarios.

### SUMMARY

When executing a task, an agent can only make decisions based on current real-time information. Once an incorrect path is selected at a certain decision point, task execution failure may result.

To solve the above technical problem, embodiments of the present disclosure provide an agent task execution method, system, medium, and electronic device. By performing path exploration using a branch agent at a second end to obtain a target path, and executing a target task by a primary agent at a first end, the task execution success rate of the primary agent can be improved.

According to a first aspect of the present disclosure, an agent task execution method is provided. The method includes: sending, by a first end, a target task to a second end; starting from a unified starting-point state of the target task, performing parallel exploration by the second end by using a plurality of branch agents, to obtain a target path corresponding to the target task; sending, by the second end, the target path to the first end; and executing, by the first end, the target task based on the target path by using a primary agent.

According to a second aspect of the present disclosure, an agent task execution system is provided. The system comprises: a primary agent deployed at a first end, being configured to send a target task to a second end; a plurality of branch agents deployed at the second end, being configured to perform parallel exploration starting from a unified starting-point state of the target task, to obtain a target path corresponding to the target task; a sending unit deployed at the second end, being configured to send the target path to the first end; and the primary agent is further configured to execute the target task based on the target path.

According to a third aspect of the present disclosure, a computer-readable storage medium is provided. The storage medium stores a computer program, and the computer program is used to implement the agent task execution method provided in the first aspect.

According to a fourth aspect of the present disclosure, an electronic device is provided. The electronic device comprises: a processor; and a memory, wherein the memory stores computer instructions; and the computer instructions, when run by the processor, cause the processor to implement the method provided in the first aspect.

According to the agent task execution method provided by the present disclosure, when the target task needs to be executed by using the primary agent at the first end, firstly, parallel exploration is performed to obtain the target path by a plurality of branch agents at the second end, and then the target task is executed based on the target path by the primary agent at the first end. Since the target path is obtained through parallel exploration by the branch agents at the second end, the risk of single-point decision errors of the agent can be reduced, and the task execution success rate can be improved. On this basis, the second end employs multiple branch agents for parallel exploration, enabling the evaluation and selection of possible execution paths obtained by the multiple branch agents, thereby solving the balancing problem between “exploration” (attempting unknown operation sequences) and “exploitation” (following known effective paths), to obtain a better solution as the target path.

### BRIEF DESCRIPTION OF DRAWINGS

The above and other objects, features, and advantages of the present disclosure will become more apparent through a more detailed description of exemplary embodiments of the present disclosure with reference to the accompanying drawings. The drawings are used to provide further understanding of the embodiments of the present disclosure and constitute a part of the specification. Together with the embodiments of the present disclosure, the drawings serve to explain the present disclosure and do not constitute a limitation on the present disclosure. In the drawings, the same reference numerals generally represent the same components or steps.

FIG. 1 is a schematic diagram of an agent task execution system according to an exemplary embodiment of the present disclosure.

FIG. 2 is a flowchart of an agent task execution method according to an exemplary embodiment of the present disclosure.

FIG. 3 is a flowchart of an agent task execution method according to another exemplary embodiment of the present disclosure.

FIG. 4 is a flowchart of an agent task execution method according to yet another exemplary embodiment of the present disclosure.

FIG. 5 is a flowchart of an agent task execution method according to a fourth exemplary embodiment of the present disclosure.

FIG. 6 is a flowchart of an agent task execution method according to a fifth exemplary embodiment of the present disclosure.

FIG. 7 is a flowchart of an agent task execution method according to a sixth exemplary embodiment of the present disclosure.

FIG. 8 is a flowchart of an agent task execution method according to a seventh exemplary embodiment of the present disclosure.

FIG. 9 is a flowchart of an agent task execution method according to an eighth exemplary embodiment of the present disclosure.

FIG. 10 is a flowchart of an agent task execution method according to a ninth exemplary embodiment of the present disclosure.

FIG. 11 is a flowchart of an agent task execution method according to a tenth exemplary embodiment of the present disclosure.

FIG. 12 is a flowchart of an agent task execution method according to an eleventh exemplary embodiment of the present disclosure.

FIG. 13 is a structural schematic diagram of an agent task execution system according to an exemplary embodiment of the present disclosure.

FIG. 14 is a structural schematic diagram of an agent task execution system according to another exemplary embodiment of the present disclosure.

FIG. 15 is a structural diagram of an electronic device according to an exemplary embodiment of the present disclosure.

### DETAILED DESCRIPTION OF THE EMBODIMENTS

Hereinafter, exemplary embodiments according to the present disclosure will be described in detail with reference to the accompanying drawings. Obviously, the described embodiments are only some embodiments of the present disclosure, rather than all embodiments of the present disclosure. It should be understood that the present disclosure is not limited by the exemplary embodiments described herein.

It should be noted that unless otherwise specifically stated, the relative arrangement, numerical expressions, and numerical values of components and steps set forth in these embodiments do not limit the scope of the present disclosure.

### Overview of Disclosure

A graphical user interface (GUI) agent (hereinafter referred to as an agent) is an artificial intelligence program capable of simulating human interaction with software interfaces, and is capable of completing specific tasks by performing operations (such as clicking, swiping, and inputting text) on various software interfaces, thereby improving operational efficiency and the level of automation. Currently, agents can be applied in scenarios requiring automated operation of graphical user interfaces, such as robotic process automation (RPA), automated software testing, and intelligent personal assistant scenarios.

When executing a task, an agent typically has the following deficiencies: First, the agent can only make decisions based on current real-time information, i.e., it can only attempt one operation path at any given moment. Once an incorrect path is selected at a certain decision point (e.g., clicking an incorrect button or entering an irrelevant menu), the agent may fall into an infinite loop or need to spend a significant amount of time on backtracking and retrying, which greatly reduces the efficiency and success rate of task execution. Second, in complex GUI environments, the agent needs to make trade-offs between “exploration” (attempting unknown operation sequences) and “exploitation” (following known effective paths). Excessive exploration may lead to low efficiency, while excessive exploitation may miss better solutions, making it difficult to achieve a balance between the two. Finally, for long-range tasks that require tens or even hundreds of steps to complete, a single erroneous decision may lead to failure of the entire task chain. As the task length increases, the probability of failure grows exponentially, making it difficult for the agent to reliably complete complex workflows.

Therefore, there is an urgent need for a method that can ensure that agents accurately and reliably execute tasks in complex, dynamic GUI environments, to improve the task execution success rate of agents.

Embodiments of the present disclosure propose a new solution that can solve the problem of low task execution success rates of agents in complex, dynamic GUI environments. Specifically, embodiments of the present disclosure provide an agent task execution method. When the first end needs to use the primary agent to execute the target task, a plurality of branch agents at the second end first perform parallel exploration to obtain the target path, and then the primary agent at the first end executes the target task based on the target path. Since the target path is obtained through parallel exploration by the branch agents at the second end, the risk of single-point decision errors of the agent can be reduced, and the task execution success rate can be improved. On this basis, the plurality of branch agents at the second end perform parallel exploration, enabling evaluation and selection among possible execution paths obtained through exploration by the plurality of branch agents, thereby addressing the trade-off between “exploration” (trying unknown sequences of operations) and “exploitation” (following known effective paths), and obtaining a superior solution as the target path.

### Exemplary System

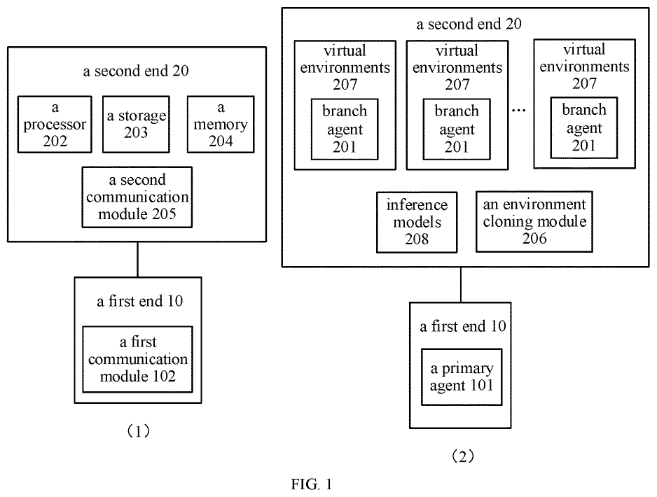

FIG. 1 is a schematic diagram of an agent task execution system according to an exemplary embodiment of the present disclosure.

As shown in FIG. 1, the agent task execution system provided by the present disclosure comprises a primary agent 101 and branch agents 201, deployed at a first end 10 and a second end 20, respectively.

First, with reference to (1) in FIG. 1, the agent task execution system provided by the present disclosure is illustratively introduced from a hardware perspective.

At the hardware level, the first end 10 may be a device having a graphical user interface, such as an in-vehicle terminal, and may also be a smartphone, a tablet computer, a laptop computer, or the like.

The first end 10 is capable of running a lightweight primary agent, and allows the primary agent to perform screen capture and simulate input operations. The first end 10 may comprise a processor, a storage, and a memory (not shown in the figure).

The first end 10 may be provided with a first communication module 102, comprising but not limited to: a wireless network module (such as a Wi-Fi module), a mobile communication module (such as a 4G/5G module), and an Ethernet module. In this way, the first end 10 has network connection capability and can perform data transmission with the second end 20, such as sending target task-related information to the second end 20.

The second end 20 may be a server, a workstation, or other device with relatively high computing capability. By way of example, the second end 20 may be a cloud server.

The second end 20 may comprise a processor 202, a storage 203, and a memory 204.

The processor 202 may load and execute program instructions to control the agent to perform the exploration method. In one example, the processor 202 may comprise a central processing unit (CPU), and the CPU may be a multi-core server-grade CPU, the number of cores being proportional to the number of branch agents 201 running in parallel; the processor 202 may further comprise a graphics processing unit (GPU) for supporting the operation and inference of an inference model, as well as supporting parallel rendering of virtual environments corresponding to the plurality of branch agents 201.

The storage 203 may be used to store processor-executable program instructions, and the processor 202 may load and execute the program instructions in the storage to implement the method of the second end 20. The storage 203 may also be used to store data, such as environment information of virtual environments corresponding to the branch agents 201, wherein the environment information of the virtual environments refers to parameter information and state information for describing the operating environment of the virtual environments. In one example, the storage 203 may be a high-speed solid-state drive (SSD) with a capacity of not less than 2 TB.

The memory 204 may be used to provide a high-speed data access space for the processor. In one example, the memory 204 may be not less than 128 GB to support the operation of a plurality of virtual environments and inference models.

The second end 20 is provided with a second communication module 205, comprising but not limited to a wired network interface, such as a gigabit or 10-gigabit Ethernet interface. In this way, the second end 20 has network connection capability and can perform data transmission with the first end 10. For example, a sending module of the second end 20 may send target path-related information to the first end 10.

Next, with reference to (2) in FIG. 1, the agent task execution system provided by the present disclosure is illustratively introduced from a software perspective.

At the software architecture level, the first end 10 and the second end 20 provided by the present disclosure may be deployed in, but are not limited to, Linux, Windows, macOS, Android, iOS, and other environments. The first end 10 and the second end 20 may be deployed in the same operating system environment or in different operating system environments. By way of example, the first end 10 may be deployed in an Android environment; the second end 20 may be deployed in a Linux environment.

In one example, the primary agent 101 may be installed in the operating system environment deployed at the first end 10.

In one example, the second end 20 may be provided with a virtualization or container environment, including but not limited to Docker, Kubernetes, and KVM. In this way, the second end 20 may create an independent virtual machine or container for each branch agent 201 through virtualization or container technology, serving as a running sandbox for the branch agent 201.

In one example, the second end 20 may be configured with an environment cloning module 206, including but not limited to Android Emulator, Anbox, Xcode Simulator, or Scrcpy. In this way, the second end 20 may create virtual environments 207 for the respective branch agents through the environment cloning module 206 within the running sandbox created through virtualization or container technology. For example, an Android emulation environment having an operating system, a screen, and applications may be created in a virtual machine, so that the respective branch agents can perform path exploration in the virtual environments 207.

In one example, the second end 20 may be equipped with a deep learning framework, such as PyTorch, JAX, TensorFlow, or the like, for the operation and inference of inference models.

In one example, the second end 20 may deploy inference models 208, including but not limited to Transformer-based vision-language models (such as GPT, CogVLM, etc.), object detection models, and the like. Additionally, the second end 20 may further integrate an optional reinforcement learning library. In this way, the respective branch agents 201 may call the inference models 208 by invoking model interfaces or the like, and the inference models 208 perform inference based on the deep learning framework, to implement the parallel exploration by the respective branch agents 201.

In one example, the second end 20 may be provided with a communication protocol module (not shown in the figure), including but not limited to: gRPC, WebSocket, or RESTful API. In this way, data transmission between the first end 10 and the second end 20 can be performed through the communication protocol module.

In one example, the second end 20 may further be configured with a database (not shown in the figure), including but not limited to Redis, Neo4j, and the like. In this way, the second end 20 may store the exploration history of the branch agents, evaluation information on explored paths, and the like.

### Exemplary Method

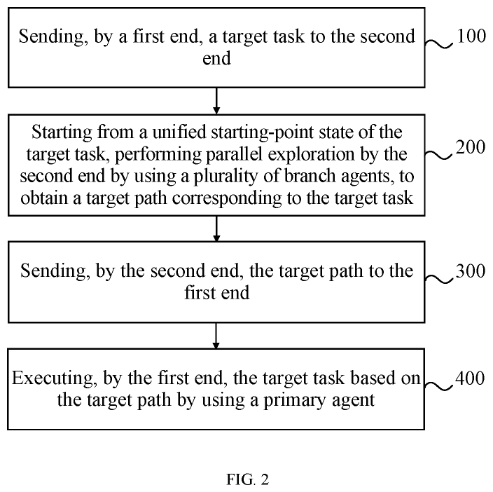

FIG. 2 is a flowchart of an agent task execution method according to an exemplary embodiment of the present disclosure. As shown in FIG. 2, the method includes the following steps:
Step 100: Sending, by a first end, a target task to a second end.

In Step 100, after determining that the target task needs to be executed, the first end may send the target task to the second end, so that the second end can perform exploration based on the target task to obtain a corresponding target path.

The following provides an illustrative description with the first end being a terminal and the second end being a cloud. For example, in response to receiving a task execution request “order a cup of milk tea for delivery” input by a user, the terminal determines the target task “order a cup of milk tea with 70% sugar for delivery” based on user historical preference information and the like, and sends information related to the target task, such as text description information, to the cloud.

Step 200: Starting from a unified starting-point state of the target task, performing parallel exploration by the second end by using a plurality of branch agents, to obtain a target path corresponding to the target task.

In Step 200, the second end performs parallel exploration by using a plurality of branch agents starting from a unified starting-point state of the target task. The unified starting-point state of the target task refers to information representing the initial state at which the target task is launched, such as the application running state and the interface display state at the time the target task is launched. For example, for the target task “order a cup of milk tea for delivery” in the foregoing example, the unified starting-point state may be “the device displays the home screen interface, the delivery APP is not launched,” and the like.

The second end may comprehensively evaluate the exploration results of each branch agent to obtain the final target path. The target path is an operation sequence from the task starting-point to the task endpoint. For example, for the target task “order a cup of milk tea for delivery” in the foregoing example, the target path P_best may be: “open the delivery APP->click the search box->input ‘XX milk tea’->click the first search result->select ‘70% sugar’->click ‘buy now’->click ‘submit order’->click ‘pay’.”

In some examples, the second end may select an optimal one from, or perform fusion on, the possible paths obtained through exploration by the plurality of branch agents, to obtain the final target path.

In some examples, the number of branch agents may be determined based on the complexity of the target task. For example, for simple tasks, a small number of branch agents may be used for parallel exploration; for complex tasks, the number of branch agents may be increased to expand the exploration breadth.

Step 300: Sending, by the second end, the target path to the first end.

In Step 300, after determining the target path, the second end sends the target path to the first end, so that the first end can complete the target task by following the target path.

Step 400: Executing, by the first end, the target task based on the target path by using a primary agent.

In Step 400, the primary agent may parse and replay the target path, and execute the target task at the first end according to the target path.

For example, for the target task “order a cup of milk tea with 70% sugar for delivery” in the foregoing example, the primary agent may sequentially execute each clicking, inputting, and other operations in the foregoing target path P_best at the terminal, ultimately completing the delivery order.

As can be seen from the above technical solution, in the method provided by the embodiments of the present disclosure, after the first end triggers the target task, the second end performs parallel exploration through a plurality of branch agents, evaluates the exploration results of the respective branch agents, and obtains the final target path. Then the primary agent at the first end sequentially executes each step in the target path, thereby completing the target task. Compared with the conventional solution using the primary agent for serial exploration, the embodiments of the present disclosure can avoid task execution failure caused by a single-path decision error through the parallel exploration by a plurality of branch agents, thereby improving the task execution success rate. In addition, in the embodiments of the present disclosure, only a lightweight primary agent runs at the first end, thereby reducing the resource occupancy rate of the first end and minimizing impact on the performance of the first end; moreover, completing the path exploration at the second end with relatively high computing capability can fully utilize the computing resources of the second end, improve the efficiency of path exploration, and shorten the completion time of the overall task.

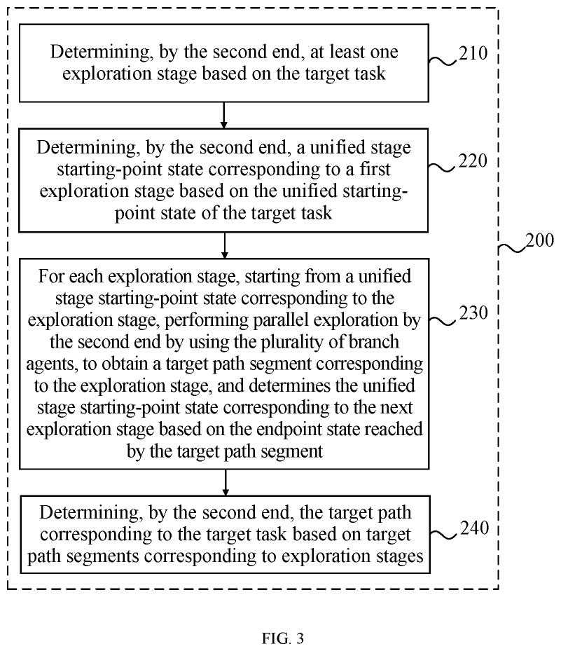

FIG. 3 is a flowchart of an agent task execution method according to another exemplary embodiment of the present disclosure. As shown in FIG. 3, on the basis of the embodiment shown in FIG. 2, Step 200 may include the following steps:
Step 210: Determining, by the second end, at least one exploration stage based on the target task.

In Step 210, the second end divides the complete exploration process into a plurality of exploration stages based on the target task. In this way, the branch agents can perform exploration in stages, proceeding to the next exploration stage after the previous exploration stage is completed.

In some examples, when dividing exploration stages, the number of exploration stages may not be determined. In this way, after the previous exploration stage is completed, the next exploration stage is divided, until the complete exploration process is finished. The completion marker of the complete exploration process may be the completion of the target task. For the above target task “order a cup of milk tea with 70% sugar for delivery,” the completion marker of the complete exploration process may be the completion of payment, such as the appearance of “payment successful” text on the interface.

Step 220: Determining, by the second end, a unified stage starting-point state corresponding to the first exploration stage based on the unified starting-point state of the target task.

In Step 220, before starting a first exploration stage, the second end first needs to determine the stage starting-point state S_1 corresponding to the first exploration stage, so that each branch agent starts parallel exploration from the unified stage starting-point state.

In one example, the stage starting-point state corresponding to the first exploration stage may be determined based on the unified starting-point state of the target task. For example, if the unified starting-point state of the target task indicates that the delivery APP has already been launched, then in the stage starting-point state corresponding to the first exploration stage, the delivery APP has also been launched. In this way, in the first exploration stage, there is no need to explore the operation step of “launch the delivery APP.”

In one example, the unified starting-point state of the target task may be determined as the stage starting-point state corresponding to the first exploration stage.

Step 230: For each exploration stage, starting from the unified stage starting-point state corresponding to the exploration stage, performing parallel exploration by the second end by using the plurality of branch agents, to obtain a target path segment corresponding to the exploration stage, and determining the unified stage starting-point state corresponding to the next exploration stage based on the endpoint state reached by the target path segment.

In Step 230, in each exploration stage, a plurality of branch agents start parallel exploration from the stage starting-point state corresponding to that exploration stage. The stage starting-point state is information representing the unified baseline state at the start of a single exploration stage, such as information representing the initial application running state and the interface display state of that exploration stage. For example, in the stage of “customizing specifications and adding to shopping cart”, the stage starting-point state may include “having entered a milk tea product detail page, specification option being set to a default option, no sweetness option being selected,” so that each branch agent can start from this stage starting-point state and parallelly explore the operation steps required for customizing specifications and adding to the shopping cart.

During the parallel exploration process, each branch agent independently executes several steps. The second end may determine the target path segment p_best corresponding to the exploration stage based on the results independently executed by each branch agent. The target path segment refers to a sequence of consecutive operation steps starting from the stage starting-point state within that exploration stage; each target path segment only covers the operations of its corresponding exploration stage; and a plurality of target path segments can be concatenated in order to form a complete target path.

Thereafter, the unified stage starting-point state corresponding to the next exploration stage may be determined based on the endpoint state reached by the target path segment corresponding to the exploration stage. In this way, the endpoint of the exploration stage and the starting-point of the next exploration stage are coherent, ensuring seamless connection of the overall exploration process, thereby ensuring that the finally obtained target path is continuous and executable.

For example, in the foregoing example, if the endpoint state reached by the target path segment corresponding to the current exploration stage indicates that “XX milk tea” has been input and a query result has been obtained, then in the unified stage starting-point state corresponding to the next exploration stage, the query result has also been obtained. In this way, in the next exploration stage, there is no need to re-input “XX milk tea” and perform the query again.

In one example, the endpoint state reached by the target path segment corresponding to the last-ranked exploration stage may serve as the endpoint state of the target task.

Step 240: Determining, by the second end, the target path corresponding to the target task based on target path segments corresponding to the exploration stages.

In Step 240, the second end concatenates the target path segments corresponding to the exploration stages in the order of the respective exploration stages, to form the final target path P_success. In this way, a coherent operation sequence from the unified starting-point state to the endpoint state of the target task can be obtained.

As can be seen from the above technical solution, the method provided by the embodiments of the present disclosure, by dividing a long-range complex target task into a plurality of consecutive exploration stages and performing parallel exploration by a plurality of agents within each exploration stage, can reduce exploration complexity, thereby improving the exploration success rate. After the exploration is completed, concatenating the target path segments corresponding to the respective exploration stages can yield a complete and executable operation sequence.

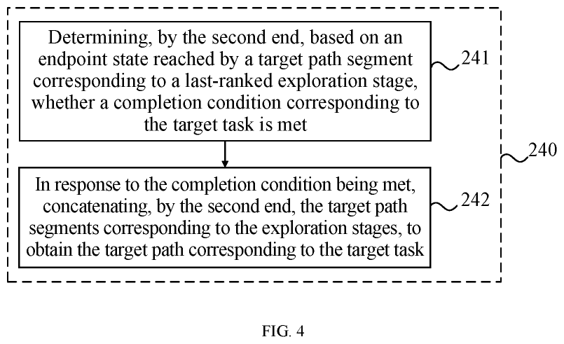

FIG. 4 is a flowchart of an agent task execution method according to yet another exemplary embodiment of the present disclosure. As shown in FIG. 4, on the basis of the embodiment shown in FIG. 3, Step 240 may include the following steps:
Step 241: Determining, by the second end, based on an endpoint state reached by a target path segment corresponding to a last-ranked exploration stage, whether a completion condition corresponding to the target task is met.

In Step 241, considering that the endpoint state reached by a target path segment corresponding to a last-ranked exploration stage may serve as the endpoint state S_best of the target task, endpoint state verification may be performed on the last-ranked exploration stage, to determine whether the endpoint state reached by the target path segment corresponding thereto meets the completion condition corresponding to the target task.

In some examples, the completion condition corresponding to the target task may be that preset content is displayed on the interface, such as the text “payment successful” or similar text displayed on the interface of the operating environment in which the branch agent is located; in other examples, the completion condition corresponding to the target task may also be that a certain application or process in the operating environment in which the branch agent is located is in a preset state, such as that the operating environment in which the branch agent is located has successfully generated and persisted an order ID (orderId) and has written it into the local order cache.

In some examples, endpoint state verification may be performed for each exploration stage after each parallel exploration thereof is completed. If it is determined that the completion condition corresponding to the target task has not been met, the next exploration stage is continued to be divided, and parallel exploration is performed in the next exploration stage; if it is determined that the completion condition corresponding to the target task has been met, exploration is stopped, and Step 242 is entered.

Step 242: In response to the completion condition being met, concatenating, by the second end, the target path segments corresponding to the exploration stages, to obtain the target path corresponding to the target task.

In Step 242, if the completion condition corresponding to the target task is met, it is considered that the last-ranked exploration stage can successfully reach the endpoint of the target task. Therefore, the second end may concatenate the target path segments p_best corresponding to the respective exploration stages in the order of the respective exploration stages, to form the final target path P_success.

For example, for the foregoing target task “order a cup of milk tea for delivery”, the optimal segment of the “searching and selecting milk tea” stage, the optimal segment of the “customizing specifications and adding to shopping cart” stage, and the optimal segment of the “filling in address and completing payment” stage may be concatenated, to obtain a complete operation sequence from search to successful order placement.

As can be seen from the above technical solution, the method provided by the embodiments of the present disclosure performs endpoint state verification on the last-ranked exploration stage, and concatenates the target path segments after the verification is passed, which can ensure that the finally obtained target path can successfully reach the endpoint of the target task, i.e., ensure that the target task can be completed by following the target path.

FIG. 5 is a flowchart of an agent task execution method according to a fourth exemplary embodiment of the present disclosure. As shown in FIG. 5, on the basis of the embodiment shown in FIG. 3, “starting from the unified stage starting-point state corresponding to the exploration stage, performing parallel exploration by the second end by using a plurality of branch agents, to obtain the target path segment corresponding to the exploration stage” in Step 230 includes the following steps:
Step 231: starting from the unified stage starting-point state, parallelly executing, in a virtual environment set to the unified stage starting-point state, the target task by the second end by using the plurality of branch agents, to obtain candidate path segments corresponding to the respective branch agents.

In Step 231, in each exploration stage, the plurality of branch agents parallelly perform exploration for that exploration stage, to obtain candidate path segments corresponding to that stage. Specifically, each branch agent, in its respective operating environment, independently executes several steps of operations for completing the target task starting from the unified stage starting-point state S_i within the exploration stage. For example, a branch agent j independently executes K steps of operations, thereby generating a candidate path segment p_j={(S_{i+1}, a_1), (S_{i+2}, a_2), . . . , (S_{i+K}, a_K)}. Here, a_1 refers to the first operation step of branch agent j, S_{i+1} refers to the state after executing the first step, and so on.

The operating environment in which each branch agent is located is set to the unified stage starting-point state before each exploration stage begins, so that each branch agent can start exploration from the stage starting-point state.

In one example, the second end may be provided with a memory module for storing and managing information related to candidate path segments explored by the respective branch agents. For example, the information stored in the memory module may be in the form of a graph database (such as Neo4j or the like), wherein each node represents a state and a hash value or feature vector of a screenshot of the interface at that state may be used as a node ID; and each edge represents an operation step. For instance, in the foregoing candidate path segment p_j, S_{i+1} may serve as a node, and a_1 may serve as an edge. As another example, the information stored in the memory module may be in the form of key-value storage (such as Redis or the like), for example, a key-value pair may be used to store one state, a composite key-value pair may be used to store one operation step, and an index may be used to indicate the association between a state and an operation step.

Step 232: evaluating the candidate path segments by the second end, and determining the target path segment from the plurality of candidate path segments based on the evaluation result.

In Step 232, after each exploration stage is completed, an evaluation and arbitration module of the second end may analyze the candidate path segments of the respective branch agents, as well as the complete information of their intermediate states, etc., and then evaluate the merits of the candidate path segments submitted by the respective branch agents. For example, a state value evaluation function V(S) may be designed in advance. The state value evaluation function V(S) refers to a function model for quantifying the potential of a candidate path segment to complete the target task. For the foregoing candidate path segment p_j, V(S) is used to verify the possibility or expected return of ultimately completing the target task starting from the last state S_{i+K} thereof. In this way, the evaluation and arbitration module may determine, among N candidate path segments {p_1, . . . , p_n} explored by N branch agents, the candidate path segment with the highest V(S) score as the target path segment p_best for that exploration stage.

V(S) may be implemented in a plurality of ways. For example, a value network may be trained to directly predict the V(S) score; or a large language model may be used for scoring, by providing the large language model with a current screenshot of the operating environment in which the branch agent is located, task description information of the target task, and an already-executed path of the branch agent, and prompting the large language model to analyze in a CoT (Chain-of-Thought) manner and give a success probability score between 0 and 1; or heuristic rules may be used, such as whether keywords related to the task objective (such as a milk tea search list, etc.) or specific UI elements (such as a “70% sugar” checkbox being checked) appear on the interface of the operating environment in which the branch agent is located.

In one example, the memory module may not only store information related to the candidate path segments, but also store the V(S) scores corresponding to each candidate path segment, as a decision basis for determining the target path segment.

As can be seen from the above technical solution, the method provided by the embodiments of the present disclosure evaluates a plurality of candidate path segments generated in parallel for each exploration stage, and then selects the target path segment therefrom, which can ensure that the target path segment is the optimal one within that exploration stage, thereby improving the overall quality of the final target path and facilitating the improvement of the task execution success rate.

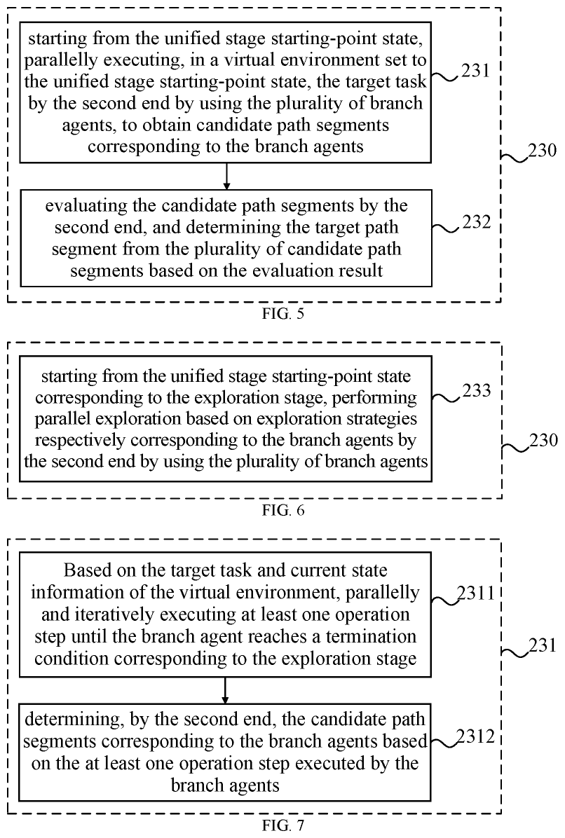

FIG. 6 is a flowchart of an agent task execution method according to a fifth exemplary embodiment of the present disclosure. As shown in FIG. 6, on the basis of the embodiment shown in FIG. 3, “starting from the unified stage starting-point state corresponding to the exploration stage, performing the parallel exploration by the second end by using the plurality of branch agents” in Step 230 includes the following step:
Step 233: starting from the unified stage starting-point state corresponding to the exploration stage, performing parallel exploration based on exploration strategies respectively corresponding to the branch agents.

In Step 233, in each exploration stage, the respective branch agents of the second end may adopt different exploration strategies for parallel exploration, to increase the diversity of exploration. For example, some branch agents may adopt zero-shot reasoning based on a large language model to generate the next operation step; and some branch agents may adopt a strategy based on reinforcement learning, such as an ε-greedy strategy, to balance between exploiting known optimal operations and exploring new operations.

As can be seen from the above technical solution, the method provided by the embodiments of the present disclosure configures different exploration strategies for the respective branch agents during the parallel exploration process, which can avoid problems such as the target path segment being a local optimum that may be caused by a single exploration strategy, thereby facilitating the improvement of the task execution success rate and task execution efficiency in complex GUI environments.

FIG. 7 is a flowchart of an agent task execution method according to a sixth exemplary embodiment of the present disclosure. As shown in FIG. 7, on the basis of the embodiment shown in FIG. 5, “parallelly executing the target task, to obtain the candidate path segments corresponding to the respective branch agents” in Step 231 may include the following steps:
Step 2311: Based on the target task and current state information of the virtual environment, parallelly and iteratively executing at least one operation step until the branch agent reaches a termination condition corresponding to the exploration stage.

In Step 2311, within each exploration stage, a branch agent analyzes the current state information of the virtual environment. For example, the branch agent may determine the next operation step to execute based on the corresponding exploration strategy, according to the gap between the current state and the state required by the target task, and the like. After the next operation step is executed, the branch agent re-analyzes the current state information of the virtual environment and the target task to determine subsequent operation steps. This process continues until the branch agent reaches the termination condition corresponding to the exploration stage, at which point the branch agent is considered to have completed exploration of that exploration stage.

The current state information of the virtual environment refers to comprehensive information representing the current running state, interface interaction state, and the like of the virtual environment in which the branch agent is located, such as information representing the interface layout, control states, and operating parameters of the virtual environment.

In one example, the current state information of the virtual environment may include interface information of the virtual environment. For example, the branch agent may analyze the current screenshot of the interface of the virtual environment to extract key visual information. Advanced vision-language models (VLMs), including but not limited to Google Gemini Pro, OpenAI GPT, and the like, may be adopted to directly generate descriptions and understanding of interface elements from images; or classic computer vision models, including but not limited to object detection models such as YOLO, Faster R-CNN, and the like, may be adopted to recognize icons, buttons, and other controls, and further combined with OCR technology to read text.

For example, in the “searching and selecting product” stage, a branch agent may analyze the current state information, determine that “XX milk tea” has already been input in the search box currently, and therefore determine, based on the current state information and the target task, that the next operation step to execute is clicking the “search” button.

Step 2312: determining, by the second end, the candidate path segments corresponding to the respective branch agents based on the at least one operation step executed by the respective branch agents.

In Step 2312, for each branch agent, the second end concatenates the operation steps executed by the branch agent in the current exploration stage, to obtain the candidate path segment corresponding to that branch agent, such as the foregoing candidate path segment p_j={(S_{i+1}, a_1), (S_{i+2}, a_2), . . ., (S_{i+K}, a_K)} corresponding to branch agent j. Here, a_1 through a_K refer to the first through K-th operation steps executed by branch agent j in the current exploration stage.

As can be seen from the above technical solution, the method provided by the embodiments of the present disclosure iteratively generates and executes the next operation step by analyzing the current state information of the virtual environment and the target task. In this way, the branch agent considers both the current state and the target to be accomplished during exploration, and can flexibly adjust when the current state changes, while ensuring that the exploration direction always points toward completing the target task. Therefore, it is conducive to shortening the exploration time and improving the exploration success rate.

FIG. 8 is a flowchart of an agent task execution method according to a seventh exemplary embodiment of the present disclosure. As shown in FIG. 8, on the basis of the embodiment shown in FIG. 7, “the branch agent reaching the termination condition corresponding to the exploration stage” in Step 2311 may include at least one of the following Steps 231a and 231b:

Step 231a: Executing, by the branch agent, a preset number of operation steps in the exploration stage.

In Step 231a, the termination condition corresponding to the exploration stage may be: the branch agent has executed a preset number of operation steps in the exploration stage. The preset number may be set based on practical application scenarios, historical experience, or the like, for example, may be set to 5. In this way, within one exploration stage, each branch agent is considered to have reached the termination condition and completed the current exploration stage after executing 5 operation steps.

It should be noted that although each branch agent executes a preset number of operation steps within one exploration stage, the time required for each branch agent to execute the preset number of operation steps may differ due to different exploration strategies, different interfaces encountered during the exploration process, and other reasons.

Step 231b: Executing, by the branch agent, the target task in the exploration stage for a preset duration.

In Step 231b, the termination condition corresponding to the exploration stage may be that: the branch agent has executed the target task in the exploration stage for a preset duration. The preset duration may be set based on practical application scenarios, historical experience, or the like, for example, may be set to 1 second. In this way, within one exploration stage, each branch agent is considered to have reached the termination condition and completed the current exploration stage after exploring for 1 second.

It should be noted that although each branch agent executes for a preset duration within one exploration stage, the number of operation steps executed by each branch agent within the preset duration may differ due to different exploration strategies, different interfaces encountered during the exploration process, and other reasons.

As can be seen from the above technical solution, the method provided by the embodiments of the present disclosure divides a complex exploration process into a plurality of short exploration stages by setting termination conditions for the exploration stages, which facilitates simplifying exploration difficulty and improving exploration efficiency and success rate, and is particularly suitable for scenarios where the target task is relatively complex. In addition, the termination conditions also facilitate controlling the exploration cost of each exploration stage and improving the utilization of exploration resources.

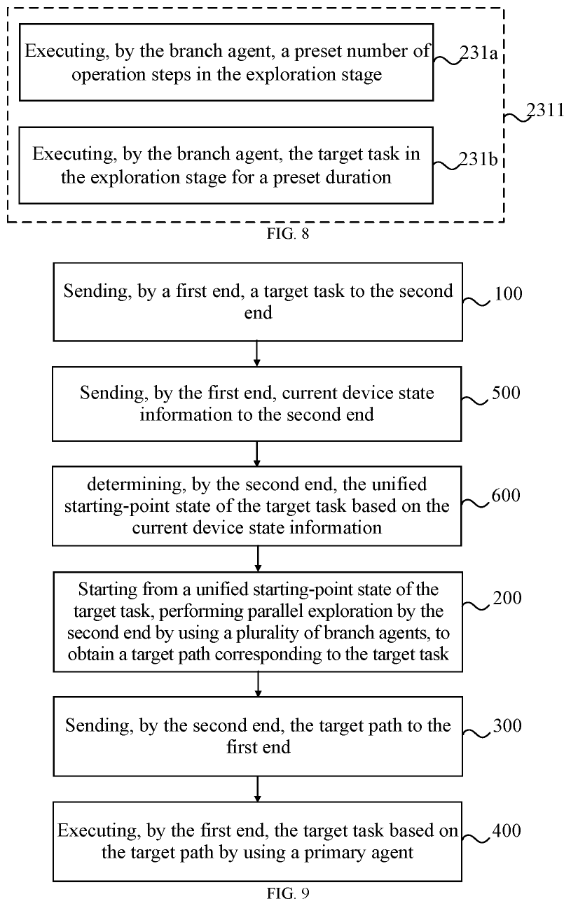

FIG. 9 is a flowchart of an agent task execution method according to an eighth exemplary embodiment of the present disclosure. As shown in FIG. 9, on the basis of the embodiment shown in FIG. 2, before Step 200, the method may include the following steps:
Step 500: Sending, by the first end, current device state information to the second end.

In Step 500, to ensure that the operating environment of the branch agents at the second end at the beginning of exploration is consistent with the actual state of the first end, the first end may synchronize the current device state information of the first end to the second end before the branch agents begin parallel exploration. The current device state information of the first end refers to information representing the current running state of the first end, such as information representing the currently running applications and the content currently displayed on the screen of the first end.

For example, after the first end receives the task execution request “order a cup of milk tea for delivery” input by the user, the primary agent may obtain the current device state information of the first end, such as a screenshot of the first end and the applications currently running at the first end, and so on, and send it to the second end through the first communication module (such as a Wi-Fi module) at the first end.

Step 600: determining, by the second end, the unified starting-point state of the target task based on the current device state information.

In Step 600, the second end receives and parses the current device state information sent by the first end, and determines the unified starting-point state of the target task based on the current device state information, as a common starting-point for all branch agents to begin parallel exploration.

For example, for the foregoing task request “order a cup of milk tea for delivery,” the second end parses the current device state information, and determines that the first end is currently displaying the home screen interface and the delivery APP is not launched. At this point, the second end may determine the unified starting-point state of the target task as “the device is on the home screen interface, and the delivery APP is not launched.” In this way, each branch agent starts exploration from this unified starting-point state. For example, the branch agent finds the icon of the delivery application on the home screen interface, opens the delivery application by clicking the icon, and then completes subsequent operation steps.

As can be seen from the above technical solution, in the method provided by the embodiments of the present disclosure, before the branch agents at the second end begin parallel exploration, the first end sends the current device state information to the second end, which can ensure that all branch agents perform parallel exploration starting from a unified starting-point state consistent with the actual state of the first end. In this way, the first operation step in the finally obtained target path can seamlessly connect with the current state of the first end, thereby improving the usability of the target path.

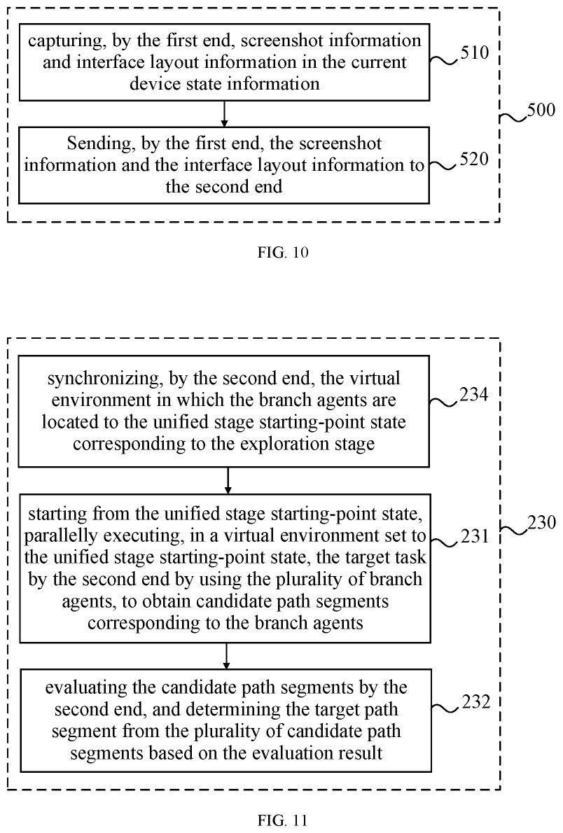

FIG. 10 is a flowchart of an agent task execution method according to a ninth exemplary embodiment of the present disclosure. As shown in FIG. 10, on the basis of the embodiment shown in FIG. 9, Step 500 may include the following steps:
Step 510: capturing, by the first end, screenshot information and interface layout information in the current device state information.

In Step 510, the current device state information sent by the first end may include screenshot information and interface layout information. The screenshot information may be image data, such as a screenshot of the screen, which may be obtained through a screenshot interface of the operating system; and the interface layout information may be structured data, such as in JSON format, XML format, or the like, which may be obtained by calling interfaces such as an Accessibility Service or an Accessibility API, or the like.

For example, the primary agent of the first end first captures a screenshot of the screen of the first end, obtaining an image including the current interface (such as the home screen interface) of the first end; meanwhile, the primary agent of the first end obtains the interface layout information by calling the Accessibility Service interface, and the interface layout information indicates that the home screen interface of the first end includes the icon of the delivery APP and indicates the specific coordinates of that icon on the home screen interface.

Step 520: Sending, by the first end, the screenshot information and the interface layout information to the second end.

In Step 520, the first end encapsulates the captured screenshot and the parsed interface layout information together, and sends them to the second end.

As can be seen from the above technical solution, in the method provided by the embodiments of the present disclosure, the first end may upload the screenshot and the interface layout information to the second end. In this way, the screenshot can provide a visual reference, and the interface layout information can provide precise data. The combination of the screenshot and the interface layout information enables the second end to accurately determine the current state of the first end.

FIG. 11 is a flowchart of an agent task execution method according to a tenth exemplary embodiment of the present disclosure. As shown in FIG. 11, on the basis of the embodiment shown in FIG. 5, before Step 231, the method may include the following step:
Step 234: synchronizing, by the second end, the virtual environment in which the branch agents are located to the unified stage starting-point state corresponding to the exploration stage.

In Step 234, before each exploration stage begins, the second end synchronizes the virtual environment in which the branch agents are located to the unified stage starting-point state corresponding to that exploration stage, so that each branch agent can perform a new round of parallel exploration starting from the same exploration progress. For example, virtual machine snapshots may be restored for the running sandboxes established at the second end; or Shared Preference data of applications in the virtual environments may be read/written, or data of applications such as the delivery APP may be reset through adb commands; or operation sequences may be precisely replayed based on the target path segment of the previous stage in each virtual environment, and the like, to synchronize the stage starting-point state of the exploration stage.

For the first exploration stage, before the first exploration stage begins, the second end may synchronize the virtual environments Env_1, . . ., Env_n in which the N branch agents are located to the unified starting-point state corresponding to the target task, such as to the state of “the device is on the home screen interface, and the delivery APP is not launched.” In this way, each branch agent can start from the same state as the first end and independently explore steps such as opening the delivery APP.

Thereafter, after each exploration stage is completed, the unified stage starting-point state of the next exploration stage is determined, and before the next exploration stage begins, each virtual environment is synchronized to that unified stage starting-point state. For example, after the stage of “searching and selecting milk tea” is completed, the unified starting-point state of the next exploration stage (the stage of “customizing specifications and adding to shopping cart”) is determined as “having successfully selected the milk tea and entered the product detail page,” then each virtual environment may be synchronized to the state of “having successfully selected the milk tea and entered the product detail page.” In this way, in the stage of “customizing specifications and adding to shopping cart”, the respective branch agents independently explore steps such as selecting “70% sugar” and adding to the shopping cart based on the same product detail page.

As can be seen from the above technical solution, the method provided by the embodiments of the present disclosure synchronizes the states of all virtual environments in which the branch agents are located before each exploration stage begins, so that within the same exploration stage, all branch agents start parallel exploration from the same state. In this way, state differences caused by inconsistent operation steps of the respective branch agents in the previous exploration stage can be eliminated, making the candidate path segments formed by all branch agents within the current exploration stage comparable. In addition, if the unified stage starting-point state corresponding to the current exploration stage is determined based on the endpoint state reached by the target path segment of the previous exploration stage, then all branch agents within the current exploration stage can start from the optimal state of the previous exploration stage, thereby inheriting the exploration achievements of the previous exploration stage, avoiding continued exploration on ineffective branches, and ensuring that the overall task advances toward the most promising direction for completing the target task. This is conducive to improving the task execution success rate and shortening the task completion time.

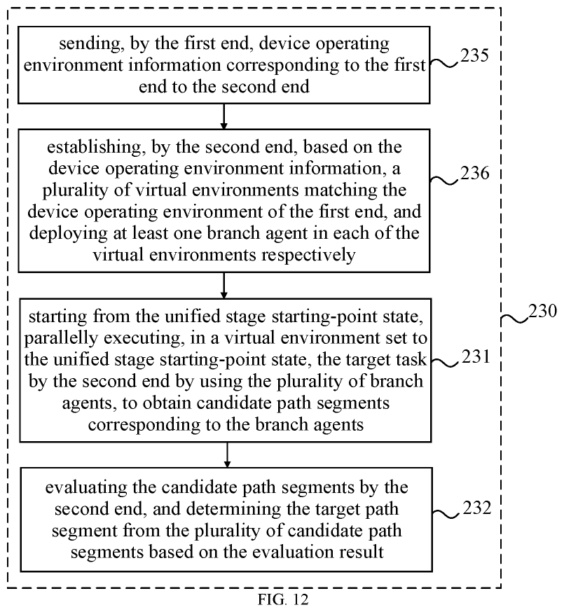

FIG. 12 is a flowchart of an agent task execution method according to an eleventh exemplary embodiment of the present disclosure. As shown in FIG. 12, on the basis of the embodiment shown in FIG. 5, before Step 231, the method may include the following steps:
Step 235: sending, by the first end, device operating environment information corresponding to the first end to the second end.

In Step 235, in order for the second end to pre-construct virtual environments consistent with the operating environment of the first end, the first end may first synchronize the device operating environment information to the second end. The device operating environment information of the first end refers to information for describing the operating environment of the first end, such as information on hardware version and configuration. The operating environment information of the first end may include, but is not limited to, the device model of the first end, the installed operating system version of the first end, the name and version number of the delivery APP installed at the first end, and the like.

In some examples, considering that the device operating environment information does not change frequently, the device operating environment information may be sent only during the first synchronization of the operating environment. Thereafter, new device operating environment information is uploaded only when the device operating environment changes; if the device operating environment has not changed, it is no longer re-uploaded, and the second end may reuse the already-synchronized device operating environment information for subsequent execution of the target task.

Step 236: establishing, by the second end, based on the device operating environment information, a plurality of virtual environments matching the device operating environment of the first end, and deploying at least one branch agent in each of the virtual environments respectively.

In Step 236, the second end receives the device operating environment information sent by the first end, and establishes a plurality of virtual environments matching the device operating environment of the first end through virtualization technology. For example, a plurality of virtual machines or containers may first be created at the second end through technologies such as Docker, K8s, and KVM, serving as running sandboxes; and then tools such as Android Emulator, Anbox, or Scrcpy may be used to launch a plurality of instances consistent with the operating system of the first end (such as an Android/iOS/desktop operating system) in the virtual machines or containers at the second end, serving as virtual environments for running the respective branch agents. Each virtual environment has the same applications and configurations installed as those at the first end.

As can be seen from the above technical solution, in the method provided by the embodiments of the present disclosure, the first end sends the device operating environment information to the second end, and the second end establishes virtual environments matching the device operating environment information. In this way, the target path obtained by the second end through parallel exploration using the branch agents can be compatible with the actual operating environment of the first end, thereby improving the usability of the target path and the task execution success rate of the target task.

It should be understood that the magnitudes of the serial numbers of the steps in the above embodiments do not imply the order of execution. The execution order of each process should be determined by its function and inherent logic, and should not constitute any limitation on the implementation process of the embodiments of the present disclosure. For example, the steps described in the above embodiments may be executed in parallel, sequentially, or in different orders, as long as the desired results of the technical solutions disclosed in the present disclosure can be achieved. The present disclosure is not limited in this regard.

### Exemplary Apparatus

The foregoing has introduced the agent task execution method provided by the embodiments of the present disclosure. It can be understood that, in order to implement the respective functions of the agent task execution method, an integrated circuit system may include corresponding hardware and software for implementing the functions of the hardware.

Those skilled in the art should easily recognize that, in combination with the steps of the agent task execution method described in conjunction with the various embodiments of the present disclosure, the various embodiments of the present disclosure can be implemented in the form of hardware, or in the form of a combination of software-driven hardware. Whether a certain function is performed by hardware or by software-driven hardware depends on the specific application and design constraints of the technical solution. A person skilled in the art may use different methods to implement the described functions for each specific application, but such implementation should not be considered as exceeding the scope of the present disclosure.

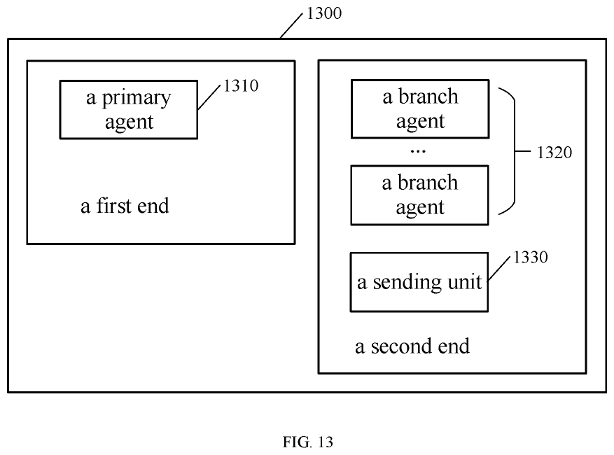

FIG. 13 is a structural schematic diagram of an agent task execution system according to an exemplary embodiment of the present disclosure. As shown in FIG. 13, in one embodiment, the agent task execution system 1300 includes: a primary agent 1310, a plurality of branch agents 1320, and a sending unit 1330.

The primary agent 1310 is deployed at the first end and is configured to send a target task to the second end.

The plurality of branch agents 1320 are deployed at the second end and are configured to perform parallel exploration starting from the unified starting-point state of the target task, to obtain a target path corresponding to the target task.

The sending unit 1330 is deployed at the second end and is configured to send the target path to the first end.

The primary agent 1310 is further configured to execute the target task based on the target path.

In an exemplary embodiment, the agent task execution system 1300 comprises an initialization module (not shown in the figure), deployed at the second end, configured to: determine at least one exploration stage based on the target task; and determine the unified stage starting-point state corresponding to the first exploration stage based on the unified starting-point state of the target task.

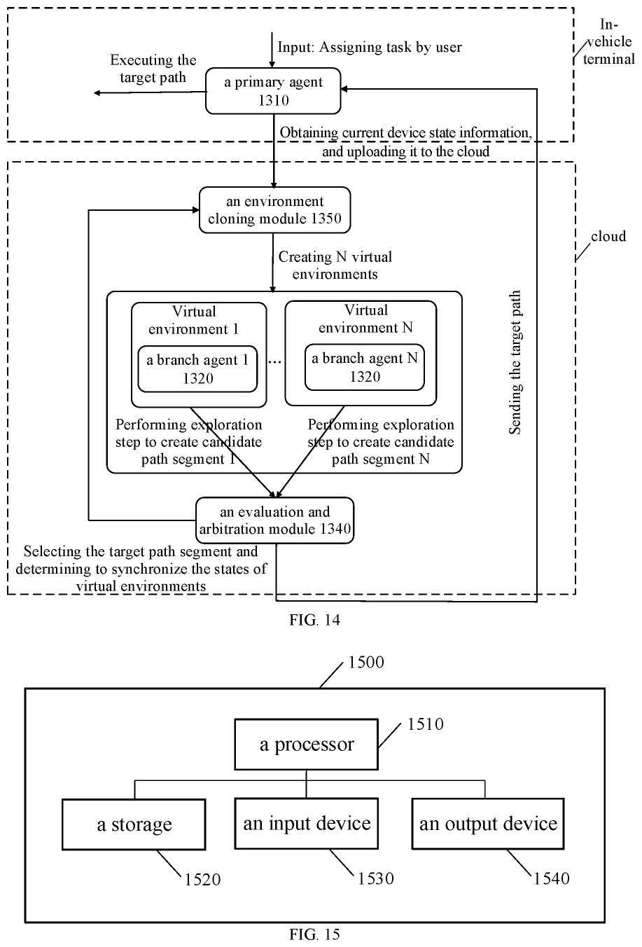

FIG. 14 is a structural schematic diagram of an agent task execution system according to another exemplary embodiment of the present disclosure. In FIG. 14, as an example, the first end is an in-vehicle terminal and the second end is a cloud.

As shown in FIG. 14, in an exemplary embodiment, the plurality of branch agents 1320 are configured to: perform parallel exploration starting from the unified stage starting-point state corresponding to the exploration stage, to obtain a target path segment corresponding to the exploration stage, and determine the unified stage starting-point state corresponding to the next exploration stage based on the endpoint state reached by the target path segment.

The agent task execution system 1300 includes an evaluation and arbitration module 1340, deployed at the second end, configured to: determine the target path corresponding to the target task based on the target path segments corresponding to the respective exploration stages.

As shown in FIG. 14, in an exemplary embodiment, the evaluation and arbitration module 1340 is configured to: determine, based on the endpoint state reached by the target path segment corresponding to the last-ranked exploration stage, whether the completion condition corresponding to the target task is met; and in response to the completion condition being met, concatenate the target path segments corresponding to the respective exploration stages, to obtain the target path corresponding to the target task.

As shown in FIG. 14, in an exemplary embodiment, the plurality of branch agents 1320 are configured to: start from the unified stage starting-point state, and parallelly execute the target task in virtual environments that are set to the unified stage starting-point state, to obtain candidate path segments corresponding to the respective branch agents 1320.

The evaluation and arbitration module 1340 is configured to: evaluate the respective candidate path segments, and determine the target path segment from the plurality of candidate path segments based on the evaluation result.

In an exemplary embodiment, the plurality of branch agents 1320 are configured to: starting from the unified stage starting-point state corresponding to the exploration stage, perform parallel exploration based on exploration strategies respectively corresponding to the branch agents 1320.

In an exemplary embodiment, the plurality of branch agents 1320 are configured to: based on the target task and current state information of the virtual environment, parallelly and iteratively execute at least one operation step until the termination condition corresponding to the exploration stage is reached.

The evaluation and arbitration module 1340 is configured to: determine the candidate path segments corresponding to the respective branch agents 1320 based on the at least one operation step executed by the respective branch agents 1320.

In an exemplary embodiment, the termination condition corresponding to the exploration stage includes: the branch agent 1320 executing a preset number of operation steps in the exploration stage; or the branch agent 1320 executing the target task in the exploration stage for a preset duration.

In an exemplary embodiment, the primary agent 1310 is configured to: send current device state information to the second end.

The initialization module is configured to: determine the unified starting-point state of the target task based on the current device state information.

In an exemplary embodiment, the primary agent 1310 is configured to: capture screenshot information and interface layout information in the current device state information; and send the screenshot information and the interface layout information to the second end.

As shown in FIG. 14, in an exemplary embodiment, the agent task execution system 1300 includes an environment cloning module 1350, deployed at the second end, configured to: synchronize the virtual environments in which the respective branch agents 1320 are located to the unified stage starting-point state corresponding to the exploration stage.

As shown in FIG. 14, in an exemplary embodiment, the primary agent 1310 is configured to: send device operating environment information corresponding to the first end to the second end.

The environment cloning module 1350 is configured to: establish, based on the device operating environment information, a plurality of virtual environments matching the device operating environment of the first end, and deploy at least one branch agent 1320 in each of the virtual environments respectively.

### Exemplary Electronic Device

FIG. 15 is a structural diagram of an electronic device according to an exemplary embodiment of the present disclosure. As shown in FIG. 15, the electronic device 1500 includes at least one processor 1510 and a storage 1520.

The processor 1510 may be a central processing unit (CPU) or another form of processing unit with data processing capability and/or instruction execution capability, and may control other components in the electronic device 1500 to perform desired functions.

The storage 1520 may include one or more computer program products, and the computer program products may include various forms of computer-readable storage media, such as volatile memory and/or non-volatile memory. The volatile memory may include, for example, random access memory (RAM) and/or cache memory. The non-volatile memory may include, for example, read-only memory (ROM), a hard disk, flash memory, and the like. One or more computer program instructions may be stored on the computer-readable storage medium, and the processor 1510 may execute the one or more computer program instructions, to implement the agent task execution method of the various embodiments of the present disclosure described above and/or other desired functions.

In one example, the electronic device 1500 may further include: an input device 1530 and an output device 1540, and these components are interconnected through a bus system and/or other forms of connection mechanisms (not shown).

The input device 1530 may further include, for example, a keyboard, a mouse, and the like.

The output device 1540 may output various information to the outside, and may include, for example, a display, a speaker, a printer, a communication network and remote output devices connected thereto, and the like.

Of course, for simplicity, only some of the components of the electronic device 1500 that are relevant to the present disclosure are shown in FIG. 15, and components such as a bus, an input/output interface, and the like are omitted. In addition, depending on specific applications, the electronic device 1500 may further include any other appropriate components.

### Exemplary Computer Program Product and Computer-Readable Storage Medium

In addition to the above method and device, the embodiments of the present disclosure may also be a computer program product, including computer program instructions that, when executed by a processor, cause the processor to perform the steps in the agent task execution method according to the various embodiments of the present disclosure described in the “Exemplary Method” section above in this specification.

The computer program product may write program code for performing the operations of the embodiments of the present disclosure in any combination of one or more programming languages. The programming languages include object-oriented programming languages such as Java, C++, and the like, and also include conventional procedural programming languages such as the “C” language or similar programming languages. The program code may execute entirely on the user computing device, partly on the user device, as an independent software package, partly on the user computing device and partly on a remote computing device, or entirely on the remote computing device or server.

In addition, the embodiments of the present disclosure may also be a computer-readable storage medium having computer program instructions stored thereon, and the computer program instructions, when executed by a processor, cause the processor to perform the steps in the agent task execution method according to the various embodiments of the present disclosure described in the “Exemplary Method” section above in this specification.

The computer-readable storage medium may employ any combination of one or more readable media. The readable medium may be a readable signal medium or a readable storage medium. The readable storage medium may include, for example, but is not limited to, an electrical, magnetic, optical, electromagnetic, infrared, or semiconductor system, apparatus, or device, or any combination of the above. More specific examples (a non-exhaustive list) of the readable storage medium include: an electrical connection having one or more conductors, a portable disk, a hard disk, random access memory (RAM), read-only memory (ROM), erasable programmable read-only memory (EPROM or flash memory), optical fiber, a portable compact disk read-only memory (CD-ROM), an optical storage device, a magnetic storage device, or any suitable combination of the above.

The basic principles of the present disclosure have been described above with reference to specific embodiments. However, it should be noted that the advantages, merits, and effects mentioned in the present disclosure are merely examples and not limitations, and these advantages, merits, and effects should not be considered as necessarily possessed by each embodiment of the present disclosure. In addition, the specific details disclosed above are merely for illustrative purposes and for ease of understanding, and are not limitations. The above details do not limit the present disclosure to the above specific details for implementation.

The block diagrams of devices, apparatuses, equipment, and systems referred to in the present disclosure are merely illustrative examples and are not intended to require or imply that the connections, arrangements, and configurations must be made in the manner shown in the block diagrams. As those skilled in the art will recognize, these devices, apparatuses, equipment, and systems may be connected, arranged, and configured in any manner. Words such as “including,” “comprising,” and “having” are open-ended words that mean “including but not limited to” and may be used interchangeably therewith. The word “or” as used herein refers to the word “and/or” and may be used interchangeably therewith, unless the context clearly indicates otherwise. The word “such as” as used herein refers to the phrase “such as but not limited to” and may be used interchangeably therewith.

It should also be noted that in the apparatus, device, and method of the present disclosure, the respective components or steps may be decomposed and/or recombined. These decompositions and/or recombinations should be considered as equivalent solutions of the present disclosure.

The above description of the disclosed aspects is provided to enable any person skilled in the art to make or use the present disclosure. Various modifications to these aspects will be readily apparent to those skilled in the art, and the general principles defined herein may be applied to other aspects without departing from the scope of the present disclosure. Therefore, the present disclosure is not intended to be limited to the aspects shown herein, but rather to accord with the broadest scope consistent with the principles and novel features disclosed herein.

The foregoing description has been presented for purposes of illustration and description. Furthermore, this description is not intended to limit the embodiments of the present disclosure to the forms disclosed herein. Although a plurality of exemplary aspects and embodiments have been discussed above, those skilled in the art will recognize certain variations, modifications, changes, additions, and sub-combinations thereof.

1. An agent task execution method, wherein the method comprises:
sending, by a first end, a target task to a second end;
starting from a unified starting-point state of the target task, performing parallel exploration by the second end by using a plurality of branch agents, to obtain a target path corresponding to the target task;
sending, by the second end, the target path to the first end; and
executing, by the first end, the target task based on the target path by using a primary agent.

2. The agent task execution method according to claim 1, wherein the starting from a unified starting-point state of the target task, performing parallel exploration by the second end by using a plurality of branch agents, to obtain a target path corresponding to the target task comprises:
determining, by the second end, at least one exploration stage based on the target task;
determining, by the second end, a unified stage starting-point state corresponding to a first exploration stage based on the unified starting-point state of the target task;
for each exploration stage, starting from a unified stage starting-point state corresponding to the exploration stage, performing the parallel exploration by the second end by using the plurality of branch agents, to obtain a target path segment corresponding to the exploration stage, and determining the unified stage starting-point state corresponding to a next exploration stage based on an endpoint state reached by the target path segment; and
determining, by the second end, the target path corresponding to the target task based on target path segments corresponding to exploration stages.

3. The agent task execution method according to claim 2, wherein the determining, by the second end, the target path corresponding to the target task based on target path segments corresponding to exploration stages comprises:
determining, by the second end, based on an endpoint state reached by a target path segment corresponding to a last-ranked exploration stage, whether a completion condition corresponding to the target task is met; and
in response to the completion condition being met, concatenating, by the second end, the target path segments corresponding to the exploration stages, to obtain the target path corresponding to the target task.

4. The agent task execution method according to claim 2, wherein the starting from a unified stage starting-point state corresponding to the exploration stage, performing the parallel exploration by the second end by using the plurality of branch agents, to obtain a target path segment corresponding to the exploration stage comprises:
starting from the unified stage starting-point state, parallelly executing, in a virtual environment set to the unified stage starting-point state, the target task by the second end by using the plurality of branch agents, to obtain candidate path segments corresponding to the branch agents; and
evaluating the candidate path segments by the second end, and determining the target path segment from the plurality of candidate path segments based on an evaluation result.

5. The agent task execution method according to claim 2, wherein the starting from a unified stage starting-point state corresponding to the exploration stage, performing the parallel exploration by the second end by using the plurality of branch agents comprises:
starting from the unified stage starting-point state corresponding to the exploration stage, performing parallel exploration based on exploration strategies respectively corresponding to the branch agents by the second end by using the plurality of branch agents.

6. The agent task execution method according to claim 3, wherein the starting from a unified stage starting-point state corresponding to the exploration stage, performing the parallel exploration by the second end by using the plurality of branch agents comprises:
starting from the unified stage starting-point state corresponding to the exploration stage, performing parallel exploration based on exploration strategies respectively corresponding to the branch agents by the second end by using the plurality of branch agents.

7. The agent task execution method according to claim 4, wherein the starting from a unified stage starting-point state corresponding to the exploration stage, performing the parallel exploration by the second end by using the plurality of branch agents comprises:
starting from the unified stage starting-point state corresponding to the exploration stage, performing parallel exploration based on exploration strategies respectively corresponding to the branch agents by the second end by using the plurality of branch agents.

8. The agent task execution method according to claim 4, wherein the parallelly executing the target task, to obtain candidate path segments corresponding to the branch agents comprises:
based on the target task and current state information of the virtual environment, parallelly and iteratively executing at least one operation step until the branch agent reaches a termination condition corresponding to the exploration stage; and
determining, by the second end, the candidate path segments corresponding to the branch agents based on the at least one operation step executed by the branch agents.

9. The agent task execution method according to claim 8, wherein the branch agent reaching the termination condition corresponding to the exploration stage comprises:
executing, by the branch agent, a preset number of operation steps in the exploration stage; or
executing, by the branch agent, the target task in the exploration stage for a preset duration.

10. The agent task execution method according to claim 1, wherein before the starting from a unified starting-point state of the target task, performing parallel exploration by the second end by using a plurality of branch agents, the method further comprises:
sending, by the first end, current device state information to the second end; and
determining, by the second end, the unified starting-point state of the target task based on the current device state information.

11. The agent task execution method according to claim 2, wherein before the starting from a unified starting-point state of the target task, performing parallel exploration by the second end by using a plurality of branch agents, the method further comprises:
sending, by the first end, current device state information to the second end; and
determining, by the second end, the unified starting-point state of the target task based on the current device state information.

12. The agent task execution method according to claim 3, wherein before the starting from a unified starting-point state of the target task, performing parallel exploration by the second end by using a plurality of branch agents, the method further comprises:
sending, by the first end, current device state information to the second end; and
determining, by the second end, the unified starting-point state of the target task based on the current device state information.

13. The agent task execution method according to claim 4, wherein before the starting from a unified starting-point state of the target task, performing parallel exploration by the second end by using a plurality of branch agents, the method further comprises:
sending, by the first end, current device state information to the second end; and
determining, by the second end, the unified starting-point state of the target task based on the current device state information.

14. The agent task execution method according to claim 10, wherein the sending, by the first end, current device state information to the second end comprises:
capturing, by the first end, screenshot information and interface layout information in the current device state information; and
sending, by the first end, the screenshot information and the interface layout information to the second end.

15. The agent task execution method according to claim 4, wherein before the starting from the unified stage starting-point state, parallelly executing, in a virtual environment set to the unified stage starting-point state, the target task by the second end by using the plurality of branch agents, the method further comprises:
synchronizing, by the second end, the virtual environment in which the branch agents are located to the unified stage starting-point state corresponding to the exploration stage.

16. The agent task execution method according to claim 4, wherein before the starting from a unified stage starting-point state corresponding to the exploration stage, performing the parallel exploration by the second end by using the plurality of branch agents, the method further comprises:
sending, by the first end, device operating environment information corresponding to the first end to the second end; and
establishing, by the second end, based on the device operating environment information, a plurality of virtual environments matching a device operating environment of the first end, and respectively deploying at least one of the branch agents in each of the virtual environments.

17. An agent task execution system, wherein the system comprises:
a primary agent deployed at a first end, being configured to send a target task to a second end;
a plurality of branch agents deployed at the second end, being configured to perform parallel exploration starting from a unified starting-point state of the target task, to obtain a target path corresponding to the target task; and
a sending unit deployed at the second end, being configured to send the target path to the first end, wherein
the primary agent is further configured to execute the target task based on the target path.

18. A non-transitory computer-readable storage medium, on which computer program instructions are stored, wherein the computer program instructions, when run by a processor, cause the processor to implement an agent task execution method, wherein the method comprises:
sending, by a first end, a target task to a second end;
starting from a unified starting-point state of the target task, performing parallel exploration by the second end by using a plurality of branch agents, to obtain a target path corresponding to the target task;
sending, by the second end, the target path to the first end; and
executing, by the first end, the target task based on the target path by using a primary agent.

19. The non-transitory computer-readable storage medium according to claim 18, wherein the starting from a unified starting-point state of the target task, performing parallel exploration by the second end by using a plurality of branch agents, to obtain a target path corresponding to the target task comprises:
determining, by the second end, at least one exploration stage based on the target task;
determining, by the second end, a unified stage starting-point state corresponding to a first exploration stage based on the unified starting-point state of the target task;
for each exploration stage, starting from a unified stage starting-point state corresponding to the exploration stage, performing the parallel exploration by the second end by using the plurality of branch agents, to obtain a target path segment corresponding to the exploration stage, and determining the unified stage starting-point state corresponding to a next exploration stage based on an endpoint state reached by the target path segment; and
determining, by the second end, the target path corresponding to the target task based on target path segments corresponding to exploration stages.

20. The non-transitory computer-readable storage medium according to claim 19, wherein the determining, by the second end, the target path corresponding to the target task based on target path segments corresponding to exploration stages comprises:
determining, by the second end, based on an endpoint state reached by a target path segment corresponding to a last-ranked exploration stage, whether a completion condition corresponding to the target task is met; and
in response to the completion condition being met, concatenating, by the second end, the target path segments corresponding to the exploration stages, to obtain the target path corresponding to the target task.
